(19) United States
(12) Patent Application Publication
(10) Pub. No.: US 2004/0209231 A1
(43) Pub. Date: Oct. 21, 2004

(54) Second language learning system

(76) Inventor: Nelson A. Merritt, Danbury, CT (US)

Correspondence Address: NELSON A. MERRITT, 3 GLEN HILL ROAD, APT 101, DANBURY, CT, 06811, US

(21) Appl. No.: 10/796,497

(22) Filed: Mar. 9, 2004

Related U.S. Application Data
(60) Provisional application No. 60/453,403, filed on Mar. 10, 2003.

(51) Int. Cl. G09B 19/06; G09B 19/00; G09B 19/08

(52) U.S. Cl. 434/156; 434/157; 434/118

(57) ABSTRACT

A learning system based on the use of games such as crossword puzzles to increase skills in learning languages. Clue lists and word lists are used to generate game matrices. Word lists are words or phrases in one language; clues may be words in another language, signs for learning sign language, and pictorial scenes such as an airport, hotel, for example. Word lists are inserted in a computer and a game matrix is generated using stored game generation software. The game may be displayed on the computer screen where a clue list and a matrix are displayed for the use of one or more persons to play. Multiple copies may be printed on all types of printed media, single sheets, pamphlets, magazines, newspapers and books. Networked computers enable several players to compete at one time. Principal relationship between the clues and word lists is the basis for a progressive learning process where the material for each successive game is designed to become increasing comprehensive. The games differ from ordinary crossword puzzles. They retain the attributes of challenge and pleasure found in ordinary games, but the clues and word lists are not random words purposed only to filling in the puzzle. They are designed to provide and enhance the learning process.

### CROSS REFERENCE TO RELATED APPLICATIONS

Provisional Patent Application Application No. 60/453/403 Filing Date Mar. 10, 2003 Confirmation No. 3088 Second Language Learning System Inventor Nelson A. Merritt

### FEDERALLY SPONSORED RESEARCH

Not applicable

### BACKGROUND OF INVENTION

References:

U.S. Pat. No. 4,369,973 January, 1983 D'Aurora 463/9; D18/7.

U.S. Pat. No. 5,178,542 January, 1993 Chigrinsky 434/157; /368; 434/370.

U.S. Pat. No. 5,282,631 February, 1994 Baker 273/272,153R,299; 434/171,177; 446/901.

U.S. Pat. No. 5,667,438 September, 1997 Rehm 463/9.

U.S. Pat. No. 4,336,020 June, 1982 Zacharin 434/157; 273/157.

Puzzles and games of all kinds are found in the art for purposes of entertainment, but few have been successfully adapted for learning enhancement devices. While crossword puzzles are widely used for entertainment, their adaptation to learning enhancement is severely limited by shortcomings in the state of their design, production and application for this purpose. The education oriented puzzle is most effective when the learning process is furnished with several stages of progressive learning sheets in order to cover the desired syllabus. A large number of such steps is required and for this reason the production of the displays must be simply carried out.

Several attempts have been made to create a puzzle methodology that is both entertaining and educational. D'Aurora, provides fixed number of puzzle formats in memory as well as a limited number of game solutions. Universal use of such a device is unduly restricted when these attributes are limited in number and not easily changeable. Chigrinsky requires a plastic overlay on the display device, severely restricting the number and variety of games for any specific syllabus. Baker utilizes strips of a material to form the matrices. This forms a cumbersome structure that severely limits the use of the puzzle even though the number of formats is theoretically unlimited. Rehm develops a series of words for the purpose of filling out the puzzle rather than requiring specific words in the word list that are correct translations of the specific clues. The result, therefore, is not learning enhancement, but game playing only. Zacharin is similarly limited in the number of games that can be played, and also is solved by matching the contours of the jigsaw puzzle instead of seeking to match word meaning of clues with solutions.

The present patent addresses a pressing need for enhancing second language learning ability. Second language proficiency is required by millions of school children and immigrants from numerous countries. Thousands of immigrants to the United States, already established in their adopted country need second language improvement. The present patent also anticipates increasing world wide on-line communications of the Internet, which brings special needs for improving inter-language knowledge devices

### SUMMARY

The present patent merges competitive game technology with learning processes to provide an integrated language-learning device. In order for learning to be most effective it is required that progressive learning from simple to comprehensive learning material be accommodated. This requires a relatively unlimited number of gaming formats to be accommodated for any particular syllabus and also requires simple means of change from one format to another. According, the apparatus of this invention utilizes standard computers with database storage and programs stored in the computer for generating game formats and output displays.

Formats based on familiar games such as commonly used crossword games require mental reasoning over and above simple memorizing. A preferred output is hardcopy, printed out by the computer where it may be reproduced simply and cheaply in quantity. The game may also be played on the face of the computer screen and over networks, including the Internet where many players may participate at the same time.

The invention comprises a series of display formats and word lists in an alternate language consisting of a group of words or phrases to be resolved and be inserted by the player. A clue list is provided in many forms—individual words, phrases, pictures, drawings, formulas and others. Games are constructed initially by inserting word lists and clue lists into the computer. Stored programs then create and print game matrices and clue lists. Also, word lists with the words inserted in the matrices can also be made available to be used as puzzle answers. Once designed, the games are stored in the computer where they may be called up as desired. Also, hard copy may be printed for making multiple copies.

An important objective of the learning enhancement system is to produce a series of progressive games for any particular syllabus. The initial games are relatively easy and the games get harder and more comprehensive as the student progresses. The key to usefulness is the ability to design many different games and make them available to large numbers of users with minimum effort and cost. The use of modern computer based technology to provide efficient design and reproduction accomplishes this, thus providing a learning process enhancement that is easy to use and relatively cost free.

### DESCRIPTION OF DRAWINGS

List of Figures

FIG. 1. Overall System Block Diagram shows

FIG. 2A. Unfilled Game and Clues

FIG. 2B. Game with Wordlist Filled In

FIG. 3. Multiple Cue List for puzzle in 2B

FIG. 4A. Vocabulary Example

FIG. 4B Vocabulary Example

FIG. 5. Various Word List Examples

### BRIEF DESCRIPTION OF DRAWINGS

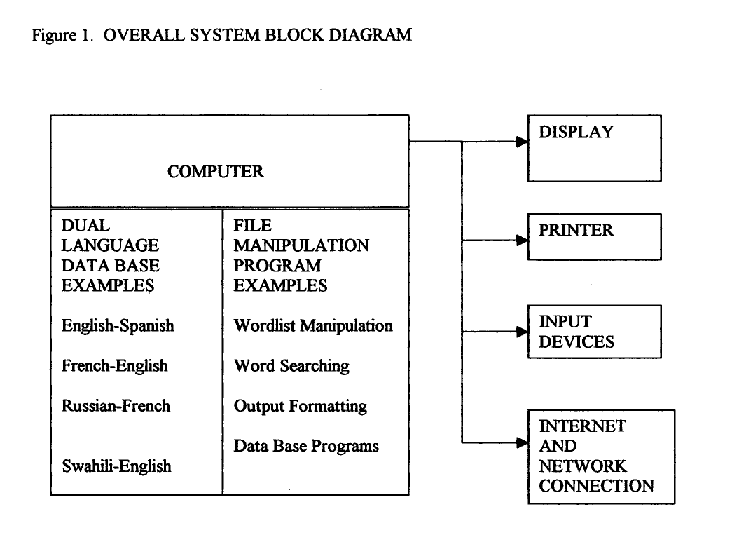

### REFER TO FIG. 1. OVERALL SYSTEM BLOCK DIAGRAM

The invention comprises a series of display formats that contain word lists and phrases in one or more languages and clues in alternate languages. Further, dual language dictionaries are stored in a standard computer as are data base programs which manipulate the stored multinational word lists so as to generate pairs of multi national word lists and the related cues. Other computer accessories include connections to a network, including the Internet.

Formats are displayed on a computer monitor or, alternately, on hard copy from the computer printer. When a computer monitor is employed, players interact with the computer as the game is played, with other players if the computer is connected to a network. The game may be printed in magazines, newspapers, or any other medium. It may be played on hand held electronic gaming devices, communication devices that have displays for displaying games, and other devices.

When hard copy printouts are employed, the learning games are played without reference or connection to the computer system, for example, when the learning games are printed on single sheet, in pamphlet form, or in book form they may be made in multiple copies and may be printed on various media.

A similar relationship exists when puzzles or games are printed in foreign language newspapers or magazines. Clues are supplied in either the magazine's native language or in the language of the country where the magazine is sold. The clues relate to word lists written in the opposite language. Alternately, the languages of the word lists and the clues may be reversed when both are in word form.

As the puzzle is generated by the computer system, a selected list of words called the wordlist, which is written in any particular selected language, is used for placement in the game format. A set of clues in the alternate language matches the individual words. A format, or matrix, is developed by the computer to fit a unique arrangement of words into the final puzzle. The format and clues are provided to the player. The wordlist, which contains the words to be inserted into the format, is not furnished to the player. Instead, the player must select these words. Finding and placing the words in the format is the object of the game.

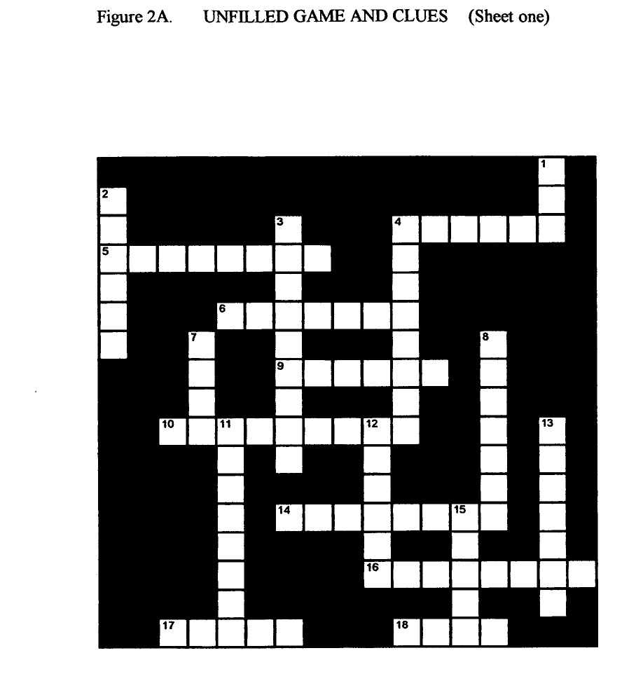

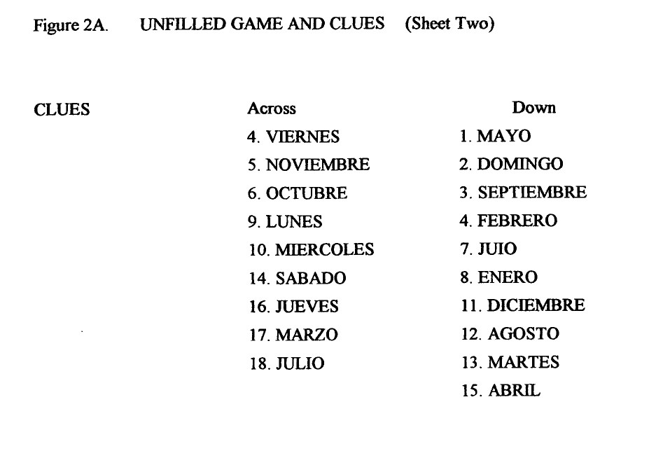

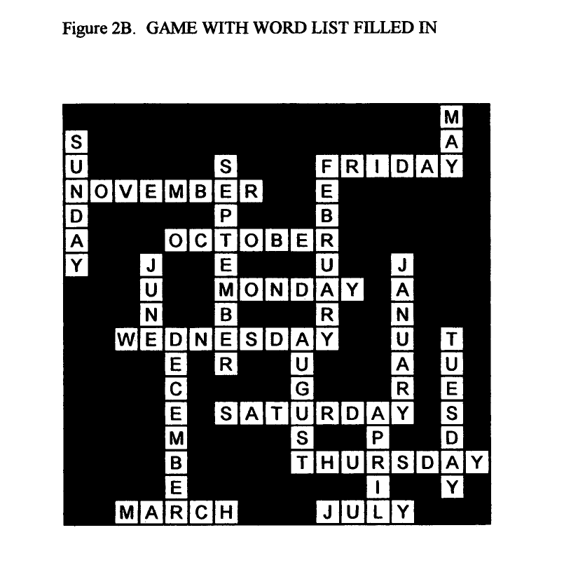

### REFER TO FIG. 2A. UNFILLED GAME AND CLUES

This figure shows an example of an unfilled game in crossword format. A set of cues is shown in Spanish language. A word list (not shown) contains a matching word in English for each of the clue words. The student searches for a suitable word in English language to match a corresponding clue in the Spanish language and places a candidate word into the proper position in the puzzle. Several tries may be needed to choose a word that satisfies the word's translation meaning and also fits in the allotted space. The letters in the common letter space of words crossing the selected word must also match those of the selected word.

The format used is, in effect, a game format because in this example each English word must fit exactly within its designated squares and must be compatible with letters supplied by crossing words in the junctions where crossing words cross the selected word. On choosing a candidate word to match the clue the student, therefore, must evaluate whether or not the word meets certain conditions in addition to meeting the translation meaning so as to meet certain format placement criteria.

Instant feedback for each move in the game is provided to the player. Feedback indicates to the player at each step whether or not the selected word is likely to be the proper word or that it is assuredly wrong. If it fits in the assigned squares it is potentially the right word, but not assuredly so. Confirmation that the selected word is assuredly the proper one is obtained only as all of many conditions is met.

When all of the crossing words have been installed and their letters in the common crossing squares match those of the selected word, then verification of correct reasoning process has been accomplished.

As the game progresses there is another additional feedback that assists the player in the reasoning process. This feedback is related to finding words not otherwise known to the player. Letters placed in common squares by crossing words supply hints to the player that help to define unknown words. As the number of words in the crossing squares increase with each additional placement additional letters involved aid the player in selecting a word candidates.

Thus, the game requires reasoning in addition to resorting only to memory. The player is involved in several ways in seeking out, placing and confirming the validity of each word. Validity requires several tests in addition to those of meeting requirements that the word be linguistically correct and that it fit in the spaces allowed. For example, if all of the conditions of successful selection are met, but the letters in common crossing spaces of a particular selection do not match the letters in those spaces supplied by other crossing words, then an iteration process starts. A conflict with other words already in place requires an iteration process for resolving incorrect selections of either the prior words or the present one. Each word, therefore, is actually submitted to many reasoning activities in addition to test of the player's memory alone.

### REFER TO FIG. 2B. GAME WITH WORD LIST FILLED IN

This figure shows the completed game.

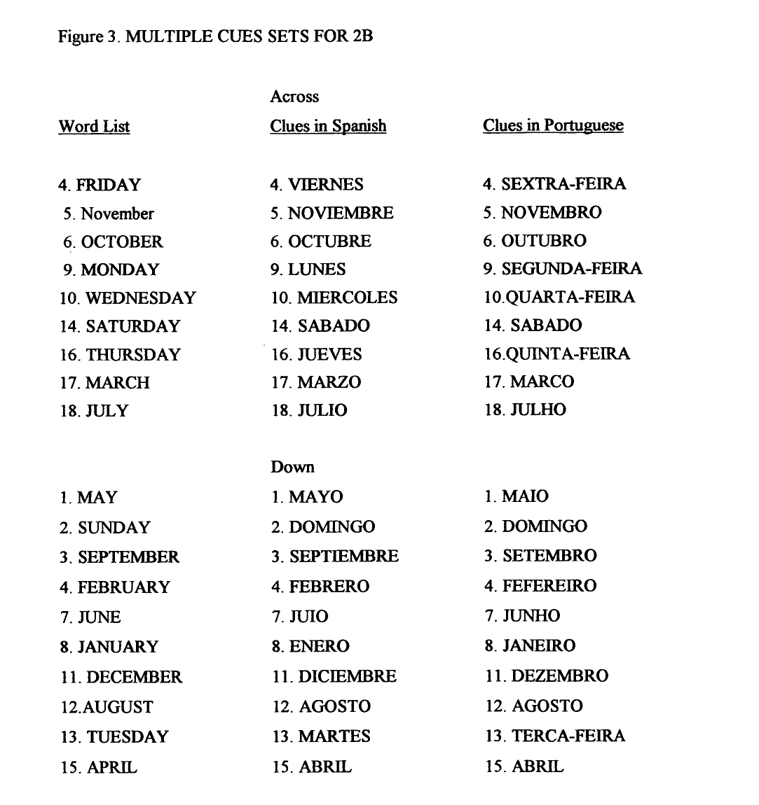

### REFER TO FIG. 3. MULTIPLE CLUE SETS

A single word list is shown with a set of cues in each of two languages, Portuguese and Spanish for the puzzle shown in FIG. 2B. This is to demonstrate that any word list may be matched to clues in any particular language. It may be matched to a set of scientific formulas, or a series of pictures, for example. A set of pictures of commonly used items, such as household utensils, when making up the clue list, will teach the alternate language names of these items. Pictures of items of interest to travelers such as airport, restaurant, post office, hotel and others may be used as clues and matched with a word list in the players' alternate language of interest.

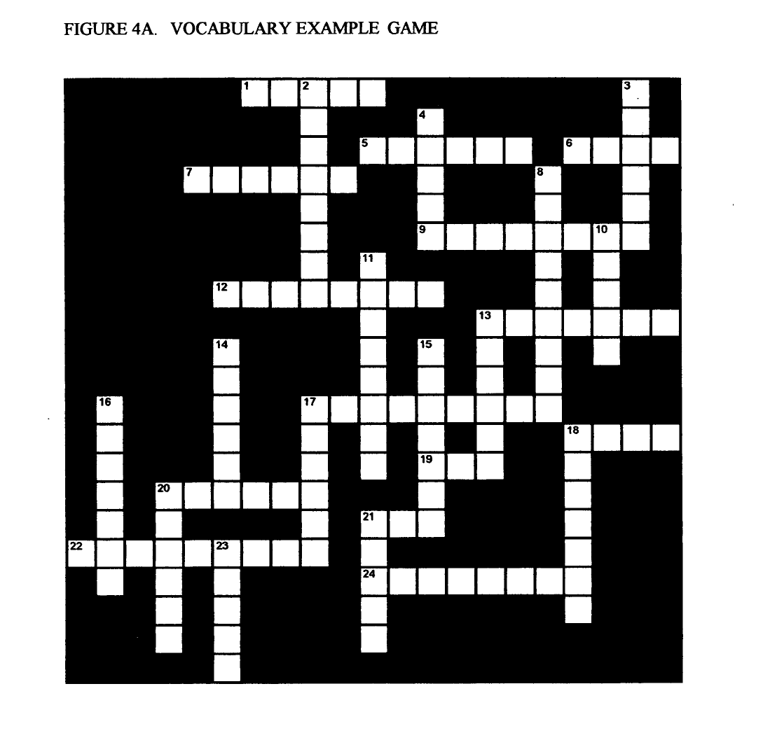

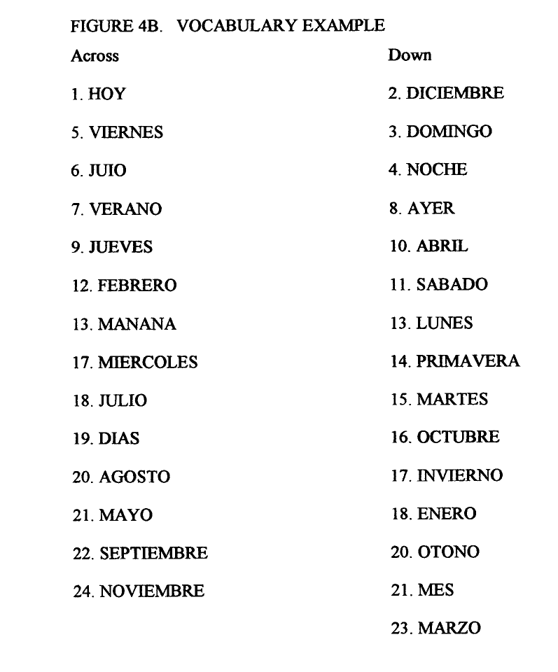

### REFER TO FIGS. 4A AND 4B. VOCABULARY EXAMPLES

These figures show a bilingual puzzle with clues listed, ready to be completed by placing each of the words in a word list in its proper slot. As in the other examples, it may be seen that the relationship of the clues to the words actually forms a vocabulary section in each language for relating one language to the other. Clues can be provided for learning specialty areas such as learning verbs, groupings of nouns, adjectives or any other class of words and grammatical relationships such as parsing, and cataloging.

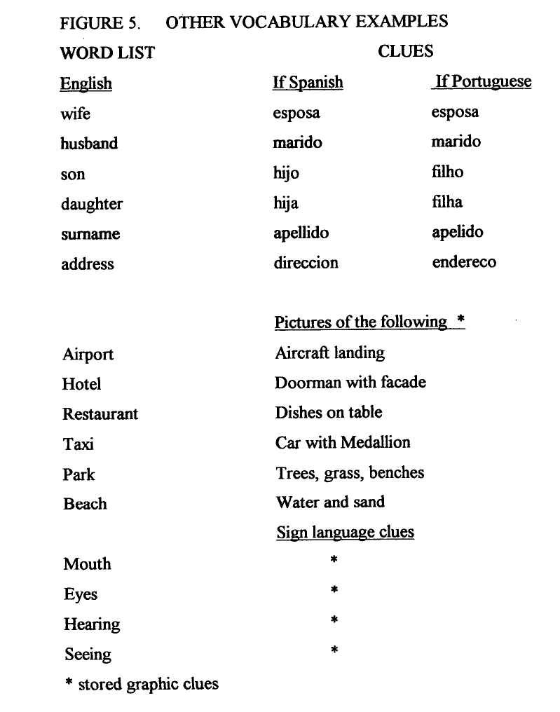

### REFER TO FIG. 5. OTHER VOCABULARY EXAMPLES

This invention constructs bilingual vocabularies in any known written language. Even the most remote and primative languages can be included. The learning games are not restricted to vocabularies, but may also included phrases, and other word combinations. Scientific relationships, written in scientific terms, can be formulated as clues and phrased in colloquial words in any language desired. New Internet words and terms, which constitute an international language by themselves, can be formatted by this invention so as to correlate one with another and with any variations that may exist in their form and usage from one country to another.

An important application of the Alternate Language Learning system is the teaching of sign language to persons with hearing and/or speech disabilities. In this application the clues are shown in the pictorial or graphic form of sign language and word lists are supplied in printed words. Any language may be used for word lists. In this way a disabled person can learn sign language not only in a native language, but can also learn sign language in any chosen alternate language.

Pictures may be used as clues with the word list being in any desired language. These examples represent a few of the variations, formats, clues and wordlist combinations. Many other combinations may be utilized in this invention.

### DETAILED DESCRIPTION OF INVENTION

This invention consists of a language learning system, specifically designed to assist a student to improve skills in one or more languages in addition to his or her native language. The language learning system was conceived to meet a pressing need for learning a second language by millions of parents and their children as they move to a new country. Many need enhancement of new language skills even though they may have some knowledge of the language of the new country.

There is also a need for second language improvement assistance for thousands of immigrants already in their adopted country, such as immigrants to the United States from Hispanic countries and others, and immigrants to European countries from African and Asian countries, for example, when these immigrants have inadequate language skills in the adopted country's language

The advent of the Internet, which enables people to communicate to any place in the world, also brings special needs for increasing inter-language knowledge. This invention anticipates increasing online communications usage by international participants. This invention will facilitate international understanding of multi-national language of commerce, science, art, travel and other areas.

The invention is also an improved recreational gaming device, which provides benefits of improving alternate language skills at the same time as enabling a new and improved game. Improved single language puzzles will be supplied with features of the language learning system in many varied areas as described herein

The invention is embodied as a system, consisting of unique forms of providing learning regimes and methods for interfacing these regimes with the student. The system utilizes a commercially available computer, either a desktop or portable. Standard databases and database programs installed in the computer serve as programs suitable for generating game formats and displays.

The learning regime, as the language learning system provides it, may be defined as a methodology of student instruction. The methodology is based on competitive game technology. In effect, the student engages in competition through the need to utilize reasoning as the game is played.

When played alone it is self-competition. It is also a group competition game when played by a number of players, when played over a network, including the Internet, or played in a group environment, such as a classroom where there is competition between several students as each strives to exceed or to perform better than classmates, for example. Game methodology in this invention is purposed to maintain a high level of student concentration in the learning process so as to enhance rate and intensity of learning.

Format of the players interface is based on formats of familiar games, an example of which is that of the commonly used varieties of crossword puzzles. Game formats require mental reasoning, over and above simple memorizing, and thus the methodology of the language learning system is a form of learning by playing a game.

The system accommodates several means of display embodiment. One is to locate display on the computer monitor where the student interacts directly with the computer. The preferred method is to use a hard copy display. The hard copy display is printed out from the computer and reproduced in hard copy, in individual sheets, or in pamphlet or book form. Multiple copies may be produced.

As in a crossword game there is a list of clues and a matching list of words called the wordlist. Clues are written in either native language or alternate and are used to select words from the word list for insertion into the puzzle. The word list is written in the opposite language from the clues.

A wordlist is developed consisting of a group of words that to be inserted into the puzzle as the game is played. The words are selected from a native language, or selected from an alternate language, as desired. Words representing a specified area of learning are assembled in a manner so as to progress through parts or all of the related area of learning. Several progressive game sheets may be required to cover the desired learning area. A game format is then designed to accommodate the physical shape, or matrix, of the game as it is printed out on hard copy, displayed on a computer monitor, or displayed on various gaming devices.

A clue list is then generated to be associated with the word list. Many forms of clues may be used, including individual words in the desired language, phrases, pictures, drawings, formulas, and others. When these three elements, word lists, clues, and format designed, the puzzle is now constructed and may be displayed and printed.

I claim:

1. An apparatus that generates leaning enhancement games such as crossword puzzles designed for that purpose.

2. Related to 1., said apparatus is assembled from modern standard computer equipment, storage, programs and output displays.

3. The learning enhancement games are progressive, beginning as simple games at the start of a syllabus and becoming progressively more comprehensive as the student continues.

4. The apparatus is designed to provide an improved means for creating various versions of games by entering wordlists and cue lists into the computer where software programs design the required matrices quickly and efficiently, allowing for creation of large quantities of games to meet the needs of progressive game matrices.
